(19) United States
(12) Patent Application Publication
(10) Pub. No.: US 2010/0167133 A1
(43) Pub. Date: Jul. 1, 2010

(54) SOLID OXIDE FUEL CELL SYSTEM

(75) Inventors: Takashi Shigehisa, Kagoshima (JP); Naruto Takahashi, Kagoshima (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Fushimi-ku, Kyoto (JP)

(21) Appl. No.: 11/993,439

(22) PCT Filed: Jun. 20, 2006
(86) PCT No.: PCT/JP2006/312307

§ 371 Date: Mar. 17, 2010

(30) Foreign Application Priority Data
Jun. 20, 2005 (JP) 2005-179020
May 31, 2006 (JP) 2006-151674

(51) Int. Cl. H01M 8/18

(52) U.S. Cl. 429/423

(57) ABSTRACT

To provide a solid oxide fuel cell system that can be controlled while taking the influence of the volume of water kept in a water tank into consideration and is fully water self-sustainable. [MEANS FOR SOLVING PROBLEMS] The solid oxide fuel cell system comprises a fuel cell (21) provided with a reforming part (22), a gas-water supply system (10) for supplying a plurality of kinds of gases and water to the reforming part (22), and a water tank (50) for storing water. The gas-water supply system (10) comprises a reforming gas supply part (12) for supplying a reforming gas, an oxygen-containing gas supply part (13) for supplying an oxygen-containing gas, and a water supply part (14) for supplying water from the water tank (50). A control unit (15) is further provided for controlling whether, based on a signal from a stored water volume sensor (51) which detects the volume of water kept in the water tank (50) for carrying out a reforming reaction in the reforming part (22), switching between an oxygen-containing gas supply part (13) and the water supply part (14) is carried out, or both the supply parts (13,14) are used in combination.

### CROSS-REFERENCE TO THE RELATED APPLICATIONS

This application is a national stage of application No. PCT/JP2006/312307 filed Jun. 20, 2006, which also claims benefit of priority under 35 U.S.C. §119 to Japanese Patent Application Nos. 2005-179020 filed Jun. 20, 2005, and 2006-151674 filed May 31, 2006, the entire contents of which are incorporated herein by reference.

### FIELD OF THE INVENTION

The present invention relates to a fuel cell system, and in particular, to a gas-water supply system of gases supplied to a gas reformer of a fuel cell.

### BACKGROUND OF THE INVENTION

In general, fuel cells are known as devices that convert energy of a fuel into electrical energy. A fuel cell generally includes a pair of electrodes disposed so as to sandwich an electrolyte. An electrochemical reaction is generated by bringing a reaction gas (fuel gas) of hydrogen into contact with a surface of one of the pair of electrodes and bringing air containing oxygen into contact with a surface of the other electrode. The fuel cell extracts electrical energy from between the electrodes utilizing this electrochemical reaction. Japanese Unexamined Patent Application Publication No. 2000-40519 (JP '519) discloses a method of operating a fuel cell system including a gas reformer. In the operation method, in order to prevent the temperature of the gas reformer from rapidly increasing, steam reforming and partial oxidation reforming are performed in combination, and the ratio of steam reforming, which is an endothermic reaction, to partial oxidation reforming is increased.

In general, in a fuel cell system that performs steam reforming, it is difficult to realize water-supply independence (i.e., to provide all the water required for the fuel cell by using condensed water). Accordingly, it is necessary to provide a line of outside compensatory water. Even if the water-supply independence can be realized, the following problems also occur: Provision of a generation means of the condensed water necessarily results in increased cost. In addition, when the water runs short, the system must be stopped. A water supply system may be frozen by the effect of the ambient temperature. The volume of condensed water is decreased. The electric power consumption is increased by using a heater for preventing freezing.

### SUMMARY OF THE INVENTION

In one aspect of the present invention, a fuel cell system comprises a fuel cell provided with a gas reformer, a water tank storing water, and a gas-water supply system for supplying a plurality of kinds of gases and water to the gas reformer. The gas-water supply system comprises a reforming gas supply unit for supplying a reforming gas to the gas reformer, an oxygen-containing gas supply unit for supplying an oxygen-containing gas to the gas reformer, a water supply unit for supplying water or steam from the water tank to the gas reformer, and a control unit for controlling whether, based on a signal from a stored water volume sensor which detects the volume of water kept in the water tank for carrying out a reforming reaction of the reforming gas with the oxygen-containing gas and/or water in the gas reformer, switching between an oxygen-containing gas supply unit and water supply unit is carried out, or both the supply units are used in combination.

In the fuel cell system, the water tank may store water condensed by exhaust heat recovery of the fuel cell.

In the fuel cell system, the water tank may store water supplied from an outside water source.

In the fuel cell system, the control unit may stop the water supply unit and switch from the water supply unit to the oxygen-containing gas supply unit so as to perform the reform reaction if the control unit, based on a signal from a stored water volume sensor, detects the volume of water in the water tank that is lower than a predetermined value (e.g., below 40%) of a rated value (e.g., maximum output power).

In the fuel cell system, the system may further comprise a generated power detector for detecting an electric power generated by the fuel cell. The control unit switches from the water supply unit to the oxygen-containing gas supply unit if the control unit, based on a signal from the generated power detector, detects the generated electric power that is lower than a predetermined value.

In the fuel cell system, the system may further comprise a cell temperature sensor for detecting a temperature of the fuel cell. The control unit switches from the water supply unit to the oxygen-containing gas supply unit if the control unit, based on a signal from the cell temperature sensor, detects the temperature that is lower than a predetermined value.

In the fuel cell system, the system may further comprise an ambient temperature sensor for detecting a temperature outside of said fuel cell system. The control unit switches from the water supply unit to the oxygen-containing gas supply unit if the control unit, based on a signal from the ambient temperature sensor, detects the temperature that is lower than a predetermined value.

In the fuel cell system, the control unit may switch between the water supply unit and the oxygen-containing gas supply unit after both the supply units operate simultaneously for a predetermined period of time.

In the fuel cell system, the water supply unit and oxygen-containing gas supply unit are connected to a gas reformer in parallel, and water can be supplied from a water tank storing water to the water supply unit. The water supply unit may supply water to the gas reformer without further treatment or steam prepared in advance to the gas reformer. Furthermore, the control unit for controlling the gas supplied from each of the water supply unit and the oxygen-containing gas supply unit to the gas reformer can switch between the water supply unit and the oxygen-containing gas supply unit on the basis of a signal from a stored water volume sensor of the water tank.

Accordingly, when the volume of water stored in the water tank is sufficient, steam reforming can be performed by supplying water only from the water supply unit to the gas reformer.

In contrast, when the water stored in the water tank runs short, partial oxidation reforming can be performed by stopping the water supply unit and switching to the oxygen-containing gas supply unit. Thus, the operation can continue without stopping the gas reformer and the total system.

In addition, by using both the water supply unit and the oxygen-containing gas supply unit in combination, a stable reforming reaction can be constantly performed while a variation in the amount of water supplied from the water tank is compensated for.

In the fuel cell system, the water tank may store condensed water generated by recovering exhaust heat of the fuel cell. In this case, the condensed water can be effectively used without disposing of the water. The amount of condensed water supplied varies, but when the volume of water stored in the water tank is sufficient, steam reforming can be performed by supplying water or steam only from the water supply unit to the gas reformer.

In contrast, when the volume of condensed water is decreased and the water stored in the water tank runs short, partial oxidation reforming can be performed by stopping the water supply unit and switching to the oxygen-containing gas supply unit. In addition, when the volume of stored water is recovered, the operation can be switched to steam reforming again. Therefore, the operation can continue without stopping the gas reformer and the total system. Thus, compensatory water need not be supplied from the outside and a complete water-supply independent system can be established.

In the fuel cell system, the water tank may store water supplied from an outside water source. In this case, when the fuel cell system is used in areas where an outside water source can be ensured (areas where water infrastructure facilities such as waterworks are provided), a sufficient amount of stored water can be obtained in the normal state. Accordingly, steam reforming can be performed by supplying water or steam only from the water supply unit to the gas reformer.

In contrast, even in areas where an outside water source can be ensured, for example, when the water stored in the water tank runs short because of stopping of water supply due to a disaster, engineering or maintenance work, or the like, partial oxidation reforming can be performed by stopping the water supply unit and switching to the oxygen-containing gas supply unit. In addition, when the stopping of the water supply ends, the operation can be switched to steam reforming again. Accordingly, the operation can continue without stopping the gas reformer and the total system.

In addition, a fuel cell system that can be used in areas where water infrastructure facilities are not provided, e.g., remote areas and deserts, without further treatment can be provided. Furthermore, for example, even when a fuel cell system which has been used in an area where water infrastructure facilities are provided (in which steam reforming has been performed) must be moved to an area where such water infrastructure facilities are not provided, this system can be used without further treatment.

Furthermore, even when the quality of water (such as public water or well water) supplied from the outside water source is decreased, partial oxidation reforming can be performed. Thus, for example, severe degradation of the fuel cell can be prevented. Such a decrease in the water quality can be detected by a sensor, and partial oxidation reforming can be performed on the basis of the detection.

Furthermore, even when a water supply pipe connected to the water tank or a water supply pipe in the water supply unit is frozen, partial oxidation reforming can be performed by stopping the water supply unit and switching to the oxygen-containing gas supply unit. When the water supply pipe becomes unfrozen, the operation can be switched to steam reforming again. Accordingly, the operation can continue without stopping the gas reformer and the total system.

In the fuel cell system, since the volume of water stored in the water tank may be detected on the basis of a signal from the stored water volume sensor, switching between steam reforming and partial oxidation reforming can be more accurately and more rapidly performed.

In the fuel cell system, when the amount of power generation is decreased to a predetermined value or lower, the performance of the fuel cell is decreased. Accordingly, in such a case, partial oxidation reforming, which is an exothermic reaction, is performed rather than steam reforming, which is an endothermic reaction, so that the temperature of the fuel cell adjacent to the gas reformer is not decreased or is increased to an appropriate temperature. Thus, the efficiency of the power generation reaction can be increased.

In the fuel cell system, when the temperature of the fuel cell is decreased, the performance of the fuel cell is decreased. Accordingly, in such a case, partial oxidation reforming, which is an exothermic reaction, is performed rather than steam reforming, which is an endothermic reaction, so that the temperature of the fuel cell adjacent to the gas reformer is not decreased or is increased to an appropriate temperature. Thus, the efficiency of the power generation reaction can be increased.

In the fuel cell system, when the ambient temperature is decreased in winter, at night, or the like and water cannot be supplied because of, for example, freezing of a water pipe or a pipe for supplying water, partial oxidation reforming is performed rather than steam reforming by switching from the water supply unit to the oxygen-containing gas supply unit. Thereby, a problem of impossibility of steam reforming due to freezing of water is eliminated. Furthermore, when the temperature of the fuel cell is decreased by the presence of the ambient temperature, it is also advantageous that partial oxidation reforming, which is an exothermic reaction, is performed.

In the fuel cell system, when switching between the oxygen-containing gas supply unit and the water supply unit is performed, an adverse effect on the fuel cell due to a rapid change can be prevented by operating both the supply unit simultaneously for a predetermined period of time. Accordingly, a reforming reaction can be gradually switched.

### BRIEF DESCRIPTION OF THE FIGURES

FIG. 1 is a block diagram that schematically shows a structure of a fuel cell system according to an embodiment of the present invention.

FIG. 2 is a block diagram that schematically shows another structure of a fuel cell system according to another embodiment of the present invention.

Reference Numerals: 1 fuel cell system; 10 gas-water supply system; 12 reforming gas supply unit; 13 oxygen-containing gas supply unit; 14 water supply unit; 15 gas supply control unit; 21 fuel cell; 22 gas reformer; 50 water tank; 51 stored water volume sensor.

### DETAILED DESCRIPTION OF THE INVENTION

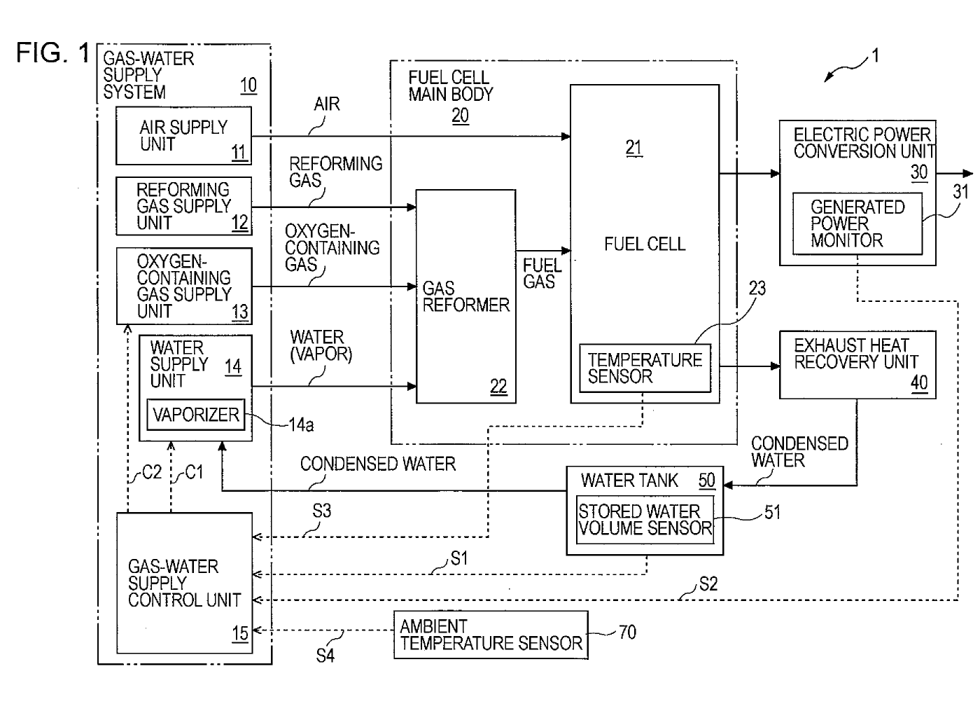

FIG. 1 is a simplified block diagram showing a solid oxide fuel cell system 1 according to an embodiment of the present invention. A fuel cell main body 20 includes a fuel cell 21 which is an assembly of cells each of which is formed by sandwiching an electrolyte between a pair of electrodes. A gas reformer 22 including a reforming catalyst therein is disposed so as to be adjacent to the fuel cell 21. Accordingly, heat generated by a power generation reaction of the fuel cell 21 and combustion heat of excess gas can be used for a reforming reaction in the gas reformer 22.

A gas-water supply system 10 that supplies a plurality of types of gases and water to the fuel cell main body 20 is provided. Each of the gases or water is supplied by an appropriate supply pipe connected to the fuel cell main body 20. An air supply unit 11 supplies the fuel cell 21 with air containing oxygen. Furthermore, a hydrogen-rich fuel gas reformed in the gas reformer 22 is supplied to the fuel cell 21. Consequently, a power generation reaction is generated and an exhaust gas at a high temperature is discharged.

The gas-water supply system 10 further includes a plurality of supply units 12 to 14 that supply the gas reformer 22 with various types of gases and water. A reforming gas supply unit 12 supplies a reforming gas used in a reforming reaction. As this reforming gas, not only an originally gaseous substance such as public gas or propane gas but also a substance obtained by vaporizing a liquid fuel such as kerosene or petroleum can be used. An oxygen-containing gas supply unit 13 supplies an oxygen-containing gas such as air. A water supply unit 14 supplies water or steam. When the water supply unit 14 supplies steam, the water supply unit 14 includes a vaporizer 14a. A description will now be made of an embodiment in which the water supply unit 14 supplies water to the gas reformer 22 without further treatment. However, when the water supply unit 14 supplies steam, control can be similarly performed.

Water supplied from the water supply unit 14 to the gas reformer 22 is necessary for steam reforming (CH₄+H₂O→3H₂+CO). On the other hand, the oxygen-containing gas supplied from the oxygen-containing gas supply unit 13 to the gas reformer 22 is necessary for partial oxidation reforming (CH₄+O₂→>2H₂+CO₂).

Supply of water to the gas reformer 22 can be allowed or stopped by, for example, operating or stopping a supply pump provided in the water supply unit 14, or opening or closing an appropriate valve. Supply of the oxygen-containing gas to the gas reformer 22 can be allowed or stopped by, for example, operating or stopping a supply pump provided in the oxygen-containing gas supply unit 13, or opening or closing an appropriate valve. Furthermore, operation and stopping of each of these supply pumps or opening or closing of each of the valves can be controlled by, for example, electrical control signals C1 and C2 output from a gas-water supply control unit 15 including a control device of the gas-water supply system 10. Accordingly, water and/or the oxygen-containing gas can be selectively supplied to the gas reformer 22.

In addition, an exhaust heat recovery unit 40 for recovering condensed water from an exhaust gas discharged from the fuel cell 21 is provided. The condensed water generated in the exhaust heat recovery unit 40 is sent to a water tank 50 and stored therein. The condensed water is supplied, as water used for steam reforming, to the gas reformer 22 through the water supply unit 14.

A stored water volume sensor 51 that detects the volume of stored condensed water is provided in the water tank 50. The stored water volume sensor 51 is a sensor, e.g., a float switch, which is switched between on and off states in accordance with a predetermined volume of water stored in the water tank 50. The predetermined stored water volume is set in advance. When the stored water volume sensor 51 detects the stored water volume, the stored water volume sensor 51 transmits the detection signal to the gas-water supply control unit 15.

The actual operation method will now be described. In the normal operation of the fuel cell, the operation of steam reforming is performed by stopping the supply of an oxygen-containing gas from the oxygen-containing gas supply unit 13 to the gas reformer 22 and supplying water in the water supply unit 14. This is because steam reforming can achieve a higher power generation efficiency and thus the loss is low. By performing steam reforming, the condensed water in the water tank 50 is consumed, while condensed water is generated in the exhaust heat recovery unit 40 and stored in the water tank 50.

The volume of condensed water stored in the water tank may be decreased for some reason (described below), and the level of the water tank may become equal to or lower than a predetermined value. In such a case, the switch of the stored water volume sensor 51 turns to the on state, and the detection signal is transmitted to the gas-water supply control unit 15 (arrow S1). Consequently, the gas-water supply control unit 15 detects that the stored volume of condensed water is small. The gas-water supply control unit 15 then stops the operation of the water supply unit 14 and starts the operation of the oxygen-containing gas supply unit 13 (arrows C1 and C2). As a result, the operation is switched from steam reforming to partial oxidation reforming.

In the case where a rapid change in the gas supply adversely affects the fuel cell 21, both the gas supply unit 13 and the water supply unit 14 operate simultaneously for a predetermined period of time, and the operation is then gradually switched to the partial oxidation reforming reaction. Alternatively, the ratio of steam reforming to partial oxidation reforming may be gradually decreased, and the ratio of partial oxidation reforming to steam reforming may be gradually increased. During partial oxidation reforming, the condensed water in the water tank 50 is not used, and condensed water is generated in the exhaust heat recovery unit 40. Accordingly, the volume of condensed water in the water tank 50 increases.

When the water volume stored in the water tank 50 becomes a high level exceeding the predetermined value, the switch of the stored water volume sensor 51 turns to the on state, and the detection signal is transmitted to the gas-water supply control unit 15 (arrow S1). Consequently, the gas-water supply control unit 15 detects that the stored volume of condensed water has been increased. The gas-water supply control unit 15 then stops the operation of the oxygen-containing gas supply unit 13 and starts the operation of the water supply unit 14 (arrows C1 and C2). As a result, the operation is switched from partial oxidation reforming to steam reforming.

In the case where a rapid change in the gas supply adversely affects the fuel cell 21, both the gas supply unit 13 and the water supply unit 14 operate simultaneously for a predetermined period of time, and the operation is then gradually switched to the steam reforming reaction. Alternatively, the ratio of steam reforming to partial oxidation reforming may be gradually increased, and the ratio of partial oxidation reforming to steam reforming may be gradually decreased.

Furthermore, when the amount of power generation is decreased to a predetermined ratio or less of a rated value, for example, 40% or less, the temperature of the fuel cell 21 adjacent to the gas reformer 22 is decreased to 650° C. because steam reforming is an endothermic reaction. Consequently, the performance of the cell is further degraded. In order to prevent this phenomenon, the amount of power generation of the fuel cell 21 or the temperature of the fuel cell 21 is detected and the operation of the water supply unit 14 is stopped, while the operation of the oxygen-containing gas supply unit 13 is started to switch from steam reforming to partial oxidation reforming. The amount of power generation of the fuel cell 21 is detected by, for example, a generated power monitor 31, and the detection signal is transmitted to the gas-water supply control unit 15 (arrow S2). The temperature of the fuel cell 21 is detected by, for example, a fuel cell temperature sensor 23 such as a thermocouple, and the detection signal is transmitted to the gas-water supply control unit 15 (arrow S3).

Since partial oxidation reforming is an exothermic reaction, a power generation reaction can be performed without decreasing the temperature of the fuel cell 21 adjacent to the gas reformer 22. In the case where a rapid change adversely affects the fuel cell 21, both the gas supply unit 13 and the water supply unit 14 operate simultaneously for a predetermined period of time, and the operation is then gradually switched to the partial oxidation reforming reaction. Alternatively, the ratio of steam reforming to partial oxidation reforming may be gradually decreased, and the ratio of partial oxidation reforming to steam reforming may be gradually increased. When the temperature of the fuel cell 21 is recovered to, for example, 700° C., the operation is then switched back to steam reforming.

Furthermore, when the ambient temperature is decreased, the temperature is detected with, for example, an ambient temperature sensor 70 such as a thermistor, and the detection signal is transmitted to the gas-water supply control unit 15 (arrow S4). In response to this signal, the gas-water supply control unit 15 stops the operation of the water supply unit 14 and starts the operation of the oxygen-containing gas supply unit 13. As a result, the operation is switched from steam reforming to partial oxidation reforming. Thereby, the problem of the impossibility of steam reforming due to freezing of water is eliminated. Furthermore, when the operating temperature of the fuel cell 21 is decreased by the presence of the ambient temperature, the same operation is performed. In the case where a rapid change adversely affects the fuel cell 21, both the gas supply unit 13 and the water supply unit 14 operate simultaneously for a predetermined period of time, and the operation is then gradually switched to the partial oxidation reforming reaction. Alternatively, the ratio of steam reforming to partial oxidation reforming may be gradually decreased, and the ratio of partial oxidation reforming to steam reforming may be gradually increased. When the ambient temperature of the fuel cell 21 is recovered to, for example, 4° C. or higher, the operation is then switched back to steam reforming. Such control can also be performed by detecting, for example, the water temperature of the water tank 50 instead of the ambient temperature.

In the case where a rapid change in the gas supply adversely affects the fuel cell 21, both the gas supply unit 13 and the water supply unit 14 operate simultaneously for a predetermined period of time, and the operation is then gradually switched to the partial oxidation reforming reaction. Alternatively, the ratio of steam reforming to partial oxidation reforming may be gradually decreased, and the ratio of partial oxidation reforming to steam reforming may be gradually increased. In a specific control method for performing this, on the basis of the value detected by temperature-detecting means provided in the gas reformer, when the detected value is higher than a predetermined temperature range (e.g., 500° C. to 700° C.), the amount of oxygen-containing gas supplied is decreased and the amount of water supplied is increased. On the other hand, when the detected value is lower than the predetermined temperature range, the amount of oxygen-containing gas supplied is increased and the amount of water supplied is decreased. The amount of oxygen-containing gas supplied and the amount of water supplied are determined so as to be within a range in which an adverse effect such as carbon precipitation does not occur.

Specifically, temperature-detecting means such as a thermocouple is provided in the gas reformer, and when a reforming reaction is performed by stopping water supply unit and operating oxygen-containing gas supply unit, the amount of oxygen-containing gas supplied and the amount of water supplied are preferably controlled so that the value detected by the temperature-detecting means does not deviate from a predetermined range.

When the operation is switched between the oxygen-containing gas supply unit and the water supply unit, an adverse effect such as carbon precipitation easily occurs under some temperature conditions of the gas reformer. However, by providing temperature-detecting means in the gas reformer and performing a reforming reaction while the amount of oxygen-containing gas and the amount water supplied are controlled so that the detected value is within a predetermined temperature range, the reforming operation can be safely switched without damage.

The fuel cell system according to an embodiment of the present invention preferably has a power generation performance of, for example, in the range of 0.5 to 1.5 kW for household use, and is preferably used as a compact distributed power supply.

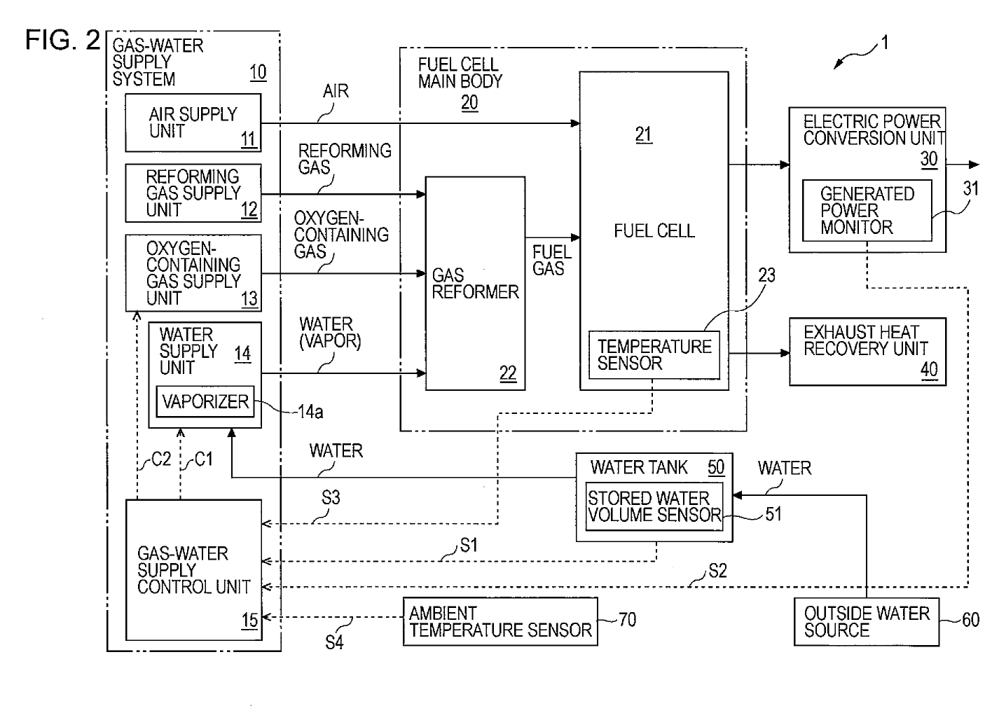

In the embodiment shown in FIG. 1, a description has been made of a case where the water tank stores water condensed by recovering exhaust heat of the fuel cell. FIG. 2 is a block diagram showing another embodiment of the present invention. In the embodiment shown in FIG. 2, a water tank 50 stores water supplied from an outside water source 60. Other structures are the same as those of the embodiment shown in FIG. 1. The outside water source 60 is, for example, a facility such as one providing public water or well water, and water is supplied to the water tank 50 by connecting appropriate piping. This structure can provide a fuel cell system that can be used, for example, in both areas where water infrastructure facilities (such as waterworks) are provided and areas where such water infrastructure facilities are not provided, e.g., remote areas and deserts. Furthermore, even when the supply of water is stopped because of a natural disaster or the like, the fuel cell system can continue to operate without stopping, and thus power supply can be reliably ensured in case of emergency such as a natural disaster. In addition, even when water cannot be supplied to the water tank 50 because of freezing of water in piping or the like, the fuel cell system can continue to operate without stopping.

Furthermore, although not shown in the figures, a system obtained by combining the embodiment shown in FIG. 1 with the embodiment shown in FIG. 2 can also be used. More specifically, the water tank may store both water condensed by exhaust heat recovery and water supplied from an outside water source. In such a case, the water tank is connected to the exhaust heat recovery means as shown in FIG. 1, and also connected to the outside water source as shown in FIG. 2. An appropriate valve that can select and switch which water should be stored and means for controlling the valve may also be provided. In such a system, when the water level of the water tank storing condensed water is decreased to a predetermined level or lower for some reason, a float switch turns to the on state and water is supplied to the water tank from the outside water source. Furthermore, when water cannot be supplied from the outside water source (e.g., public water) for some reason and the water level is decreased to a predetermined level or lower, the float switch turns to the on state and partial oxidation reforming can be performed.

1-8. (canceled)

9. A fuel cell system comprising:
a fuel cell;
a gas reformer supplying a fuel gas to the fuel cell;
a gas-water supply unit for supplying separately a reformer gas, an oxygen-containing gas and water to the gas reformer;
a sensor for detecting a change in a condition of the fuel cell system while water is being supplied;
a gas-water supply control unit for switching from supplying the water to supplying the oxygen-containing gas on the basis of the change detected by the sensor.

10. The fuel cell system according to claim 9, wherein the change in condition of the fuel cell system is a change in an operating condition of the fuel cell system.

11. The fuel cell system according to claim 10, wherein the gas-water supply control unit switches from the oxygen-containing gas to the water when the condition returns to a predetermined level.

12. The fuel cell system according to claim 10, wherein the sensor indicates an amount of water supplied to the gas reformer.

13. The fuel cell system according to claim 10, further comprising a water tank, wherein the sensor detects a water volume of the water tank.

14. The fuel cell system according to claim 10, wherein the sensor detects an electric power generated by the fuel cell.

15. The fuel cell system according to claim 9, wherein the sensor detects an ambient temperature.

16. The fuel cell system according to claim 10, wherein the sensor detects a quality of the water.

17. The fuel cell system according to claim 10, wherein the sensor detects a temperature of the fuel cell.

18. The fuel cell system according to claim 13, further comprising a steam condenser, wherein the steam condenser is connected to the water tank.

19. The fuel cell system according to claim 18, wherein steam is condensed vapor using exhaust heat recovery in the steam condenser.

20. The fuel cell system according to claim 13, wherein the water tank is connected to the outside water source.

21. A method in a fuel cell system for supplying gas and water to a gas reformer which supplies a fuel gas to a fuel cell to generate an electric power, the method comprising steps of:
supplying water and a reforming gas to the gas reformer to carry out a reforming reaction;
detecting a change in condition of the fuel cell system while the water is supplied; and
switching from water to oxygen-containing gas to the gas reformer on the basis of the change so as to maintain the reforming reaction to form the fuel gas.

22. The method according to claim 21, wherein the oxygen-containing gas is supplied to the gas reformer when an amount of the water stored in a tank is less than a predetermined level.

23. The method according to claim 21, wherein the oxygen-containing gas is supplied to the gas reformer when enough water can not be supplied to the gas reformer.

24. The method according to claim 21, wherein the oxygen-containing gas is supplied to the gas reformer when the amount of power generation is decreased to a predetermined ratio or less of a rated value.

25. The method according to claim 21, wherein the oxygen-containing gas is supplied to the gas reformer when a temperature of the fuel cell is lower than a predetermined value of a rated value.

26. The method according to claim 21, wherein the oxygen-containing gas is supplied to the gas reformer when an ambient temperature of the fuel cell system is lower than a predetermined value.

27. The method according to claim 21, wherein the oxygen-containing gas is supplied to the gas reformer when a quality of the water supplied to the gas reformer is lower than a predetermined value.

28. The method according to claim 21, wherein the water is stopped supplying after the oxygen-containing gas is supplied to the gas reformer.

29. A fuel cell system comprising:
a fuel cell;
a gas reformer connected to the fuel cell;
a reforming gas supply unit for supplying a reforming gas to the gas reformer;
a water supply unit for supplying water to the gas reformer in a normal operation of the fuel cell;
an oxygen-containing gas supply unit for supplying an oxygen-containing gas to the gas reformer;
wherein the oxygen-containing gas is supplied to the gas reformer when a shortage or possible shortage of the supplied water occurs.

30. The fuel cell system according to claim 29, wherein water is supplied to the gas reformer when the shortage of the supplied water is over or will be over.

31. A fuel cell system comprising:
a fuel cell;
a gas reformer supplying fuel gas to the fuel cell;
a reforming gas supply unit for supplying reforming gas to the gas reformer;
a water supply unit for supplying water to the gas reformer;
an oxygen-containing gas supply unit for supplying oxygen-containing gas to the gas reformer; and
a gas-water supply control unit controlling the water supply unit and the oxygen-containing gas supply unit;
wherein the gas-water supply control unit allows the water supply unit to supply water to the gas reformer in a normal operation of the fuel cell, and allows the water supply unit to stop the water and the oxygen-containing gas supply unit to supply oxygen-containing gas to the gas reformer.

32. A method for operating a fuel cell system which comprises a fuel cell to generate an electric power and a gas reformer to supply fuel gas to the fuel cell, the method comprising:
a steadily operating step of supplying water to carry out a reforming reaction with water and reforming gas;
a switching step of introducing oxygen-containing gas to the gas reformer and stopping the water;
an working step of perform engineering or maintenance work on supply-water line; and
a resuming step of reintroducing water to the gas reformer and stopping the oxygen-containing gas after the work is finished.
